(19) United States
(12) Patent Application Publication
(10) Pub. No.: US 2025/0243089 A1
(43) Pub. Date: Jul. 31, 2025

(54) NOVEL MAGNETIC METAL ORGANIC FRAMEWORK MATERIAL FOR BARIUM COLLECTION FROM PRODUCED WATER

(71) Applicant: SAUDI ARABIAN OIL COMPANY, Dhahran (SA)

(72) Inventors: Jian Hou, Beijing (CN); Tianping Huang, Beijing (CN); Fahd Alghunaimi, Dhahran (SA); Norah Aljuryyed, Dhahran (SA); Tao Chen, Dhahran (SA)

(73) Assignees: SAUDI ARABIAN OIL COMPANY, Dhahran (SA); ARAMCO FAR EAST (BEIJING) BUSINESS SERVICES CO., LTD., Beijing (CN)

(21) Appl. No.: 18/693,919

(22) PCT Filed: Jan. 31, 2024
(86) PCT No.: PCT/CN2024/074700

§ 371 Date: Mar. 20, 2024

(51) Int. Cl. C02F 1/28; B01J 20/02; B01J 20/22; B01J 20/28; C02F 1/48; C02F 101/20

(52) U.S. Cl. CPC C02F 1/288; B01J 20/0229; B01J 20/226; B01J 20/28007; B01J 20/28009; B01J 20/28061; B01J 20/2808; C02F 1/488; C02F 2101/20; C02F 2209/10

(57) ABSTRACT

Compositions and methods for barium collection. Compositions for barium collection include a magnetic metal oxide core and a metal organic framework material. The metal organic framework material is coated on a surface of the core. The metal organic framework material includes a transition metal, an organic ligand chemically bonded to the transition metal, and an inorganic ion. Methods for barium collection include mixing a composition for barium collection with a water source containing barium and adsorbing an amount of barium from the water source to produce a barium-adsorbed composition and a resultant solution. Methods for barium collection also include separating barium from produced water using a magnetic force.

### BACKGROUND

In oil and gas production processes, underground barium ions will be produced out with formation water. Barium concentrations in formation water may range from several parts per million (ppm) to thousands of ppm. Barium is a toxic element, and therefore, collection of barium from produced water is beneficial for reuse and recycling of produced waters.

The presence of sulfate ions in seawater represents potentials of scaling and formation damage problems in upstream applications when combined with high concentrations of calcium, barium or strontium often found in formation waters. Precipitation with barium has proved to be an effective method to remove sulfates. However, barium is relatively expensive to produce and therefore, the acquisition of natural barium from formation waters is a sustainable and cost effective way to provide barium for such applications.

However, while various materials have been reported to adsorb barium from wastewaters, the adsorption capability of these materials is limited. Accordingly, there exists a continuing need to develop materials having greater adsorption capacities with a high selectivity towards barium, as compared to other cations present in formation water.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a composition for barium collection. The composition for barium collection includes a core, where the core is a magnetic metal oxide, and a metal organic framework material. The metal organic framework material is coated on a surface of the core. The metal organic framework material includes a transition metal, an organic ligand chemically bonded to the transition metal, and an inorganic ion.

In another aspect, embodiments disclosed herein relate to a method for barium collection. The method for barium collection includes mixing a composition for barium collection with a water source containing barium. The composition for barium collection includes a core, where the core is a magnetic metal oxide, and a metal organic framework material. The metal organic framework material is coated on a surface of the core. The metal organic framework material includes a transition metal, an organic ligand chemically bonded to the transition metal, and an inorganic ion. The method further includes adsorbing, using the composition for barium collection, an amount of barium from the water source to produce a barium-adsorbed composition and a resultant solution.

In yet another aspect, embodiments disclosed herein relate to a method for separating barium from produced water. The method includes separating, using magnetic force, a barium-adsorbed composition from an admixture of produced water and a composition for barium collection. The composition for barium collection includes a core, where the core is a magnetic metal oxide, and a metal organic framework material. The metal organic framework material is coated on a surface of the core. The metal organic framework material includes a transition metal, an organic ligand chemically bonded to the transition metal, and an inorganic ion.

Other aspects and advantages of the claimed subject matter will be apparent from the following description and the appended claims.

### BRIEF DESCRIPTION OF DRAWINGS

FIG. 1 shows the chemical structure of a composition for barium collection according to one or more embodiments.

FIG. 2 illustrates a system for barium collection according to one or more embodiments.

FIG. 3 is a flowchart for a method according to one or more embodiments.

FIG. 4A is a scanning electron microscopy (SEM) image of carboxylic acid modified Fe3O4 according to one or more embodiments.

FIG. 4B is a transmission electron microscopy (TEM) image of carboxylic acid modified Fe3O4 according to one or more embodiments.

FIG. 5A is an SEM image of modified organic framework (MOF) according to one or more embodiments.

FIG. 5B is a TEM image of MOF according to one or more embodiments.

FIG. 6 is an SEM image of a composition for barium collection according to one or more embodiments.

FIG. 7 shows barium adsorption capacity in deionized water according to one or more embodiments.

FIG. 8A shows barium adsorption capacity in high salinity water according to one or more embodiments.

FIG. 8B shows calcium and magnesium adsorption capacity in high salinity water according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope of the invention should not be considered limited to the specific arrangement of steps shown in the flowcharts.

Although multiply dependent claims are not introduced, it would be apparent to one of ordinary skill that the subject matter of the dependent claims of one or more embodiments may be combined with other dependent claims.

Embodiments disclosed herein relate to improved methods and materials for barium collection from water. Specialty materials, such as metal organic framework (MOF) materials, have aroused interest in barium adsorption applications. MOFs generally have high adsorption capabilities toward cations. In addition, MOFs may be flexibly designed by the addition of different functional groups to tailor selectivity towards a target chemical species. The selectivity towards certain chemical species is especially important when using MOFs in oilfield applications, where formation waters often contain high salinity and/or high concentrations of ionic species other than the target species. Other ionic species present in formation waters may compete with the adsorption of the target species, thereby lowering the adsorption capacity of the MOF towards the target species.

Embodiments disclosed herein describe a novel magnetic-metal organic framework material which may be used to effectively absorb and collect barium from water, in the absence or presence of high salinity and other ions such as calcium and magnesium which are commonly found in produced water. In particular embodiments, the magnetic core is Fe₃O₄, and surface MOF is composed of Zr⁴⁺ with aminoterephthalic acid (BDC-NH₂) as ligands. And the material is treated with H₂SO₄ to be Fe₃O₄@Zr-BDC-NH₂—SO₄ for high selectivity towards barium.

### Composition for Barium Collection

In one aspect, embodiments disclosed herein relate to a composition for barium collection. The composition for barium collection includes a core and an MOF material, where the MOF material may be disposed on the surface of the core as a coating. The core of the composition for barium collection may be a magnetic metal oxide. The MOF material may include a transition metal, an organic ligand, and an inorganic ion. The organic ligand may be chemically bonded to the transition metal.

In one or more embodiments, the size of the composition for barium collection is about 10 nm to 30 nm. For example, the size of the composition for barium collection may be in a range having a lower limit of any one of 100, 1000, and 2500 nm and an upper limit of any one of 3000, 4000, and 5000 nm, where any lower limit may be paired with any upper limit.

In one or more embodiments, the average pore size of the composition for barium collection is about 5 Å to 10 Å. For example, the pore size of the composition for barium collection may be in a range having a lower limit of any one of 5 Å, 6 Å, and 7 Å and an upper limit of any one of 8 Å, 9 Å, and 10 Å, where any lower limit may be paired with any upper limit.

In one or more embodiments, the surface area of the composition for barium collection is greater than 100 m²/g. For example, the surface area of the composition for barium collection may be greater than 100 m²/g, greater than 500 m²/g, or greater than 1000 m²/g.

As defined herein, “saturation adsorption capacity” refers to a measure of the maximum capacity of adsorbate that an adsorbent can hold. Below the saturation adsorption capacity, the adsorption amount depends on an initial concentration of adsorbate and adsorbent. In general, a fixed amount of adsorbent will adsorb more adsorbate from a solution when more adsorbate is initially present in the solution. At a certain concentration of adsorbate, the amount of adsorbate which can be adsorbed by the fixed amount of adsorbent, will reach a plateau, thereby reaching the saturation adsorption capacity.

In one or more embodiments, the composition for barium collection has a saturated adsorption capacity toward barium of at least 500 mg/g. For example, the composition for barium collection may have a saturated adsorption capacity toward barium of 500 mg/g, 1000 mg/g, 2000 mg/g, or 5,000 mg/g.

In one or more embodiments, the core in the composition for barium collection is a magnetic metal oxide. For example, the magnetic metal oxide may be selected from the group consisting of (Fe₃O₄), γ-Fe₂O₃, or Fe₂O₃ modified with oxides of Ba, Sr, Co, La, Mn, Zn, Ni, and combinations thereof.

The magnetic metal oxide of one or more embodiments is a nanoparticle. In one or more embodiments, the size of the magnetic metal oxide is about 10 nm to 30 nm. For example, the size of the magnetic metal oxide may be in a range having a lower limit of any one of 10, 15, and 20 nm and an upper limit of any one of 25 and 30 nm, where any lower limit may be paired with any upper limit.

In one or more embodiments, the magnetic metal oxide is modified with a functional surface group to enable bonding with the MOF material. In some embodiments, the metal oxide surface is modified by a carboxylic acid group. In some embodiments, the carboxylic acid functional group may be added to the magnetic metal oxide surface during synthesis of the metal oxide. In some embodiments, citric acid or humic acid in the synthesis of iron oxide, providing the carboxylic acid functional group to the magnetic metal oxide surface. In some embodiments, the carboxylic acid functional group may be added to the magnetic metal oxide surface after synthesis of the metal oxide. In some embodiments, the magnetic metal oxide surface is modified by mercaptoacetic acid or mercaptopropionic acid after the magnetic metal oxide is synthesized.

In one or more embodiments, the MOF material included in the composition for barium collection includes a transition metal, an organic ligand, and an inorganic ion. The organic ligand may be chemically bonded to the transition metal.

In one or more embodiments, the MOF material includes at least one transition metal. The transition metal may be selected from the group consisting of zirconium (Zr) and chromium (Cr).

In one or more embodiments, the MOF material includes an organic ligand. The organic ligand may be selected from the group consisting of aminoterephthalic acid (BDC-NH₂), terephthalic acid (BDC), 1,3,5-benzenetricarboxylic acid, 2-mercaptomalic acid, meso-dimercaptosuccinic acid, and piperazine-1,4-dicarboxylic acid.

In one or more embodiments, the MOF material includes an inorganic ion. The inorganic ion may be sulfate (SO₄²⁻). In some embodiments, the MOF is treated with an acid after synthesis to bond the inorganic ion to the MOF. In specific embodiments, the MOF is Zr-BDC-NH₂ which is treated with H₂SO₄ such that the SO₄²⁻ ion bonds to the MOF as Zr-BDC-NH₂—SO₄.

In one or more embodiments, the organic ligand is chemically bonded to the transition metal, forming a secondary building unit (SBU). The geometry of the SBU formed by the chemical bond between the organic ligand and the transition metal cluster may be square, hexagonal, or diamond.

In one or more embodiments, the MOF material is disposed on the surface of the magnetic core as a coating in the composition for barium collection.

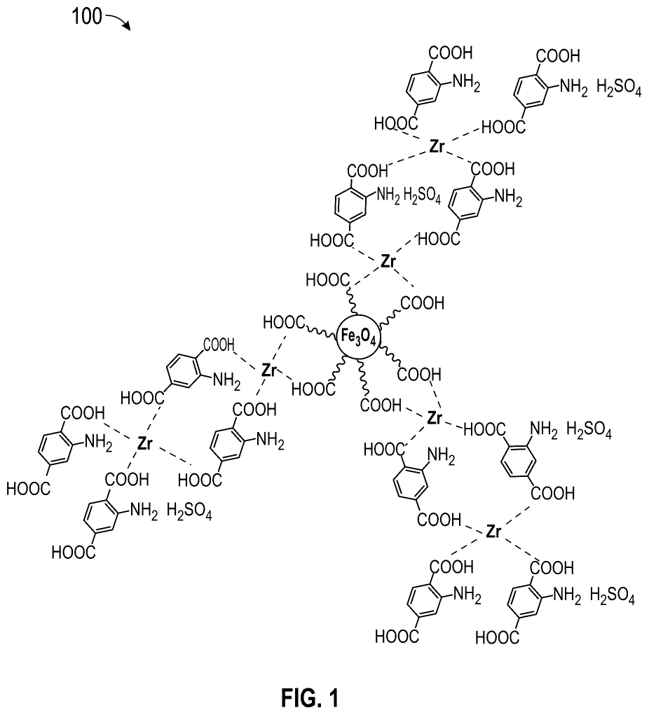

FIG. 1 shows a chemical structure 100 of the composition for barium collection according to one or more embodiments. In the example chemical structure 100 of FIG. 1, the magnetic metal oxide is Fe₃O₄, illustrated by a sphere in the center of the chemical structure. The Fe₃O₄ shown in FIG. 1 includes carboxylic acid functional groups bonded to the surface of Fe₃O₄. The MOF is also shown in FIG. 1, where the MOF is composed of Zr⁴⁺ with aminoterephthalic acid (BDC-NH₂) as the organic ligand. The MOF in the chemical structure 100 also includes SO₄²⁻, such that the MOF structure is Zr-BDC-NH₂—SO₄. The zirconium in the MOF is linked to the Fe₃O₄ surface though coordination with the carboxylic acid group.

### Method for Synthesizing a Composition for Barium Collection

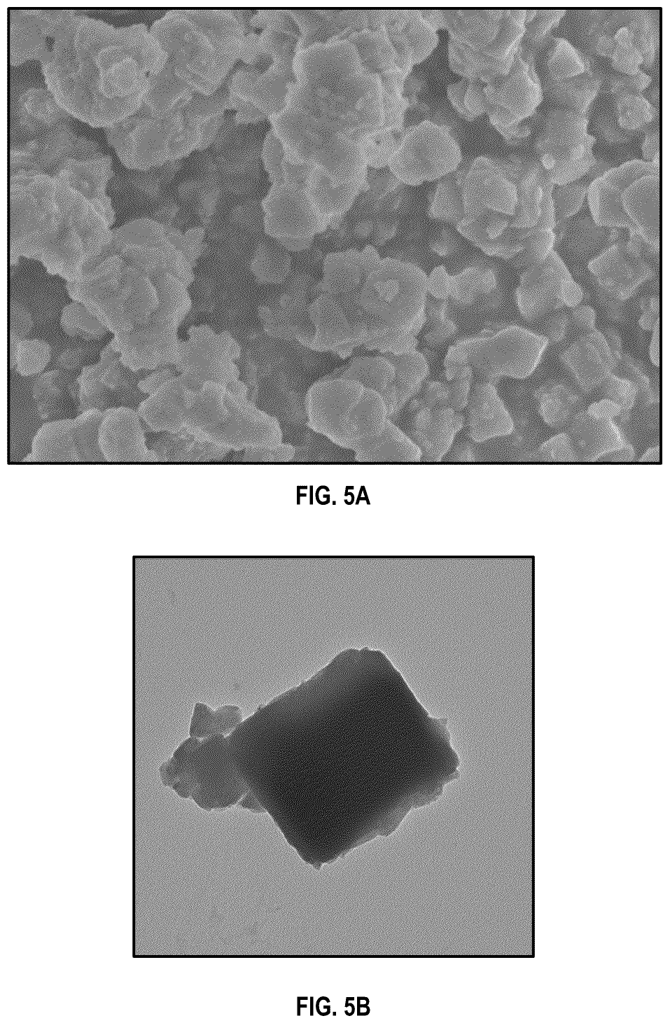

The invention provides a novel material with magnetic Fe3O4 as the core, and the surface was coated with Zr-BCD-NH₂ MOF. The Zr is linked to Fe3O4 surface though coordination with carboxylic group. After hydro-thermal synthesis Fe₃O₄@Zr-BDC-NH₂ material, it is treated with H₂SO₄ as Fe₃O₄@Zr-BDC-NH₂—SO₄ for better selectivity. The composition for barium collection according to one or more embodiments may be synthesized by methods disclosed in [insert reference to 18733-1689001/SA91689]. The chemical structure diagram of this material is presented in FIG. 5.

### System for Barium Collection

Embodiments disclosed herein also relate to a system for barium collection. The system for barium collection may include a water source, a delivery system, a magnet, and a collection system.

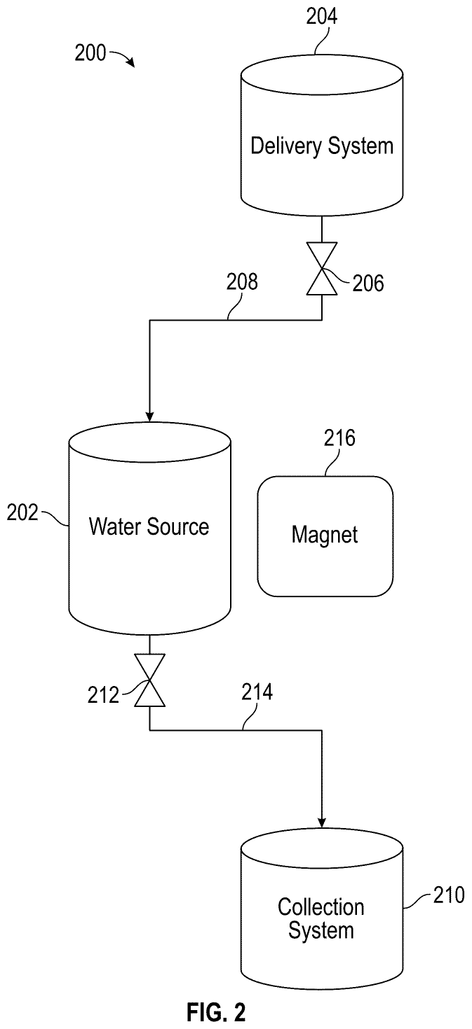

FIG. 2 shows a system for barium collection in accordance with one or more embodiments. The system 200 of FIG. 2 includes a water source 202, where the water source 202 includes a concentration of barium. The container holding the water source 202 may be an open holding system or systems, such as a pond or tank, or a closed tank system.

Although not explicitly shown, it will be understood by one of ordinary skill in the art that the system may include other units or processes necessary for carrying out methods according to one or more embodiments. For example, additional valves, pumps, mixers, and the like may also be used in systems and methods disclosed herein.

The water source 200 of one or more embodiments may be any water source which has a concentration of barium. For example, the water source may be formation water, produced water, an aquifer, industrial wastewater, combinations thereof, and the like.

The system 200 of FIG. 2 also includes a delivery system 204. The delivery system 204 includes a composition for barium collection, as described in detail in the previous sections. In one or more embodiments, the water source 202 is fluidly connected to the delivery system 204 via a delivery line 208. The delivery system 204 may include a delivery valve 206 disposed on the delivery line 208. The delivery valve 206 may be used to control flow of a fluid within the delivery system, such as the composition for barium collection.

The delivery valve 206 of one or more embodiments may be any suitable valve known in the art capable of controlling a fluid. For example, the delivery valve may be a gate valve, a globe valve, a check valve, a plug valve, a ball valve, a butterfly valve, a pressure relief valve, or the like.

The system 200 of FIG. 2 also includes a collection system 210. The collection system 210 may be fluidly connected to the water source 202 via a collection line 214. The collection system 210 may include a collection valve 212 disposed on the collection line 214. The collection valve 212 may be used to control flow of a fluid flowing from the water source 202 to the collection system 210 via the collection line 214.

The collection valve 212 of one or more embodiments may be any suitable valve known in the art capable of controlling a fluid. For example, the collection valve may be a gate valve, a globe valve, a check valve, a plug valve, a ball valve, a butterfly valve, a pressure relief valve, or the like.

The system 200 of FIG. 2 may also include a magnet 216. In some embodiments, the magnet 216 is located proximate an external surface of a container holding the water source 202. When the magnet 216 is turned “on” (i.e., when a magnetic field is actively created by the magnet), the composition for barium collection of one or more embodiments may be attached in an inner surface of the container holding the water source 202. When the magnet is turned “off” (i.e., when a magnetic field is not actively being created by the magnet), the composition for barium collection may be dispersed throughout the container holding the water source 202.

In one or more embodiments, the strength of the magnet 216 is based on a volume of the water source and subsequently an amount of the composition for barium collection to be used in the water source.

### Method for Barium Collection

Embodiments disclosed herein also relate to a method for barium collection. The method for barium collection may include producing a composition for barium collection, mixing the composition with a water source, and adsorbing, using the composition, an amount of barium from the water source.

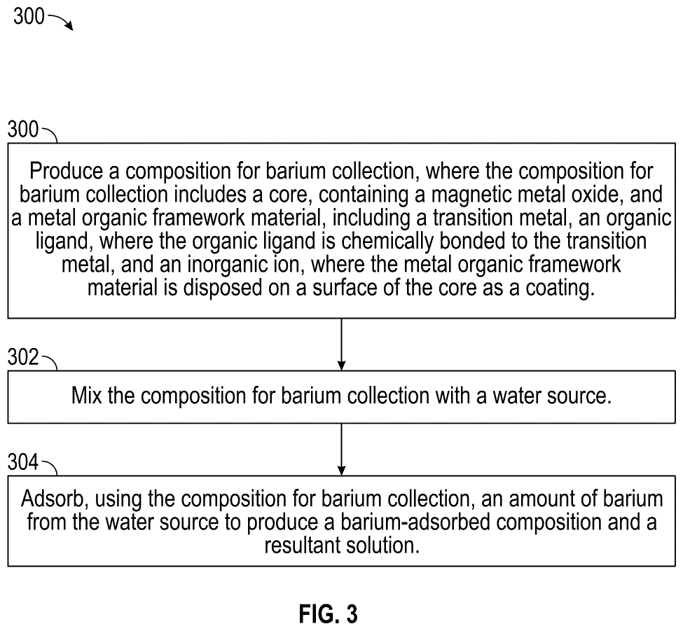

FIG. 3 is a flowchart of a method for barium collection according to one or more embodiments. The method 300 of FIG. 3 includes, in step 302, producing a composition for barium collection, where the composition for barium collection includes a core, containing a magnetic metal oxide, and a metal organic framework material, including a transition metal, an organic ligand, where the organic ligand is chemically bonded to the transition metal, and an inorganic ion, where the metal organic framework material is disposed on a surface of the core as a coating.

The method 300 of FIG. 3 also includes, in step 304, mixing the composition for barium collection with a water source. Such mixing may include techniques to agitate the admixture, including mechanical mixers or use of an injected flow of air to make a vortex in the admixture. The amount of composition added to the water source may be selected depending on the barium content of the water source and the saturation adsorption capacity toward barium of the composition. For example, the concentration of the composition for barium collection in the water source may range from 10 ppm to 10,000 ppm.

The method 300 of FIG. 3 also includes, in step 306, adsorbing, using the composition for barium collection, an amount of barium from the water source to produce a barium-adsorbed composition and a resultant solution. Such adsorption may occur through adequate exposure of the composition to the water source containing barium.

Following adsorption of the barium into the composition, the barium-adsorbed composition may be separated from the resultant solution through the use of magnets. As mentioned above, the core of the composition for barium collection includes a magnetic component, and thus, application of a magnetic force, whether by directly exposing a magnetic material to the admixture so that the barium-adsorbed composition is attracted to the magnetic material or by applying a magnetic force to a vessel containing the admixture as the resultant solution is drained from the vessel, may allow for the separation of the barium-adsorbed composition from the resultant solution (having a lower barium content than the water source).

In some embodiments, the method 300 of FIG. 3 further includes delivering, using a delivery line fluidly connected to a delivery system, the composition for barium collection to the water source, separating, using magnetic force, the barium-adsorbed composition from the resultant solution, and collecting, using a collection line fluidly connected to a collection system, the barium-adsorbed composition, where the delivery system is fluidly connected to the water source via the delivery line and the collection system is fluidly connected to the water source via the collection line.

In one or more embodiments, the water source may be alkaline, and as such, may have a pH ranging from 7 to 10. For example, the produced water may have a pH ranging from a lower limit of one of 7.0, 7.2, 7.4, 7.6, 7.8, and 8.0 to an upper limit of one of 8.0, 8.2, 8.4, 8.6, 8.8, 9, 9.2, 9.4, 9.6, 9.8 and 10.0, where any lower limit may be paired with any mathematically compatible upper limit.

In some embodiments, the water source has a total dissolved solids concentration in a range of from about 0 ppm to about 100,000 ppm. For example, the TDS of the water source may be in a range having a lower limit of any one of 0, 100, 1,000, and 10,000 ppm and an upper limit of any one of 10,000, 25,000, 50,000 and 100,000 ppm, where any lower limit may be paired with any upper limit.

In one or more embodiments, the water source has a high concentration of barium ions. For example, the water source may include barium ions in a concentration ranging from about 1 to about 5,000 ppm.

In one or more embodiments, the water source has a concentration of calcium ions in a range of from about 0 ppm to about 5,000 ppm. For example, the concentration of calcium ions in the water source may be in a range having a lower limit of any one of 0, 100, and 1,000 ppm and an upper limit of any one of 2,000, 4,000, and 5,000 ppm, where any lower limit may be paired with any upper limit.

In one or more embodiments, the water source has a concentration of magnesium ions in a range of from about 0 ppm to about 1,000 ppm. For example, the concentration of calcium ions in the water source may be in a range having a lower limit of any one of 0, 100, and 500 ppm and an upper limit of any one of 600, 750 and 1,000 ppm, where any lower limit may be paired with any upper limit.

In some embodiments, the water source has a concentration of calcium ions in a range of from about 1 to about 5,000 ppm and a concentration of magnesium ions in a range of from about 1 to about 1,000 ppm.

As mentioned previously, the composition for barium collection of one or more embodiments has a saturation adsorption capacity toward barium of at least 500 mg/g. As will be shown in the Example section, below embodiments where the water source contains any range of TDS, including 0 ppm (i.e., deionized water) and when the water source has a concentration of calcium ions in a range of from about 1 to about 5,000 ppm and a concentration of magnesium ions in a range of from about 1 to about 1,000 ppm, the saturation capacity toward barium of the composition for barium collection remains at least 500 mg/g. In other words, the saturation capacity toward barium of the composition for barium collection is not negatively affected by the presence of other ions, such as magnesium, calcium, or the like in the water source.

In one or more embodiments, method 300 may be carried out on site, i.e., at a wellsite where the water source, such as produced water, originated, at a wellsite where the water source is subsequently used, or both. The method may be carried out on site via a batch process, a semi-batch process, or a continuous process. For example, in a batch process, a single vessel may be used, and the various components of the chemical process are added to the vessel via pumps. In embodiments in which a batch process is used, the composition for barium collection may be disposed in a vessel and activated if necessary. In some embodiments, the composition for barium collection is poured into the vessel as particles and may be cyclically used, adsorbing barium from the water source, (such as produced water) and being separated from the resultant solution, as described above. The produced water would be added to the vessel and held for the desired residence time for the adsorption to occur. In some embodiments, a flow of air is injected into the vessel through an inlet to make a vortex in the solution, so that the composition for barium collection can disperse and fully contact with the water source for a good adsorption efficiency. After suitable adsorption of barium ions onto the particles, the water (having a reduced barium content) may be removed, e.g., via pumping, draining, or pressuring, from the vessel. A magnet or other mechanism may be used to retain the adsorbent particles in the vessel as the resultant solution having a reduced barium content is separated therefrom.

Methods of removing sulfate from seawater described herein are cost-effective, efficient, and environmentally friendly, as they provide the reuse of the barium adsorbent and the repurposing of seawater on site.

Advantages of embodiments disclosed herein may include the following. Compositions and methods of collecting barium from water sources such as produced water described herein are cost-effective, efficient, and environmentally friendly, as they provide a natural source of barium.

The barium loading and adsorption efficiency are much higher than commercially available alternatives. In addition, barium selectively of the composition of one or more embodiments in high salinity water is superior to commercially available alternatives. Commercially available alternatives will adsorb calcium or magnesium, and the barium adsorption efficiency is generally very low in high salinity water. But the adsorption capacity of barium using the composition of one or more embodiments is not affected by the salinity of water.

### EXAMPLES

The following examples are provided for the purpose of further illustrating the present compositions and methods but are in no way to be taken as limiting.

Examples disclosed herein illustrate the synthesis and characterization of the composition for barium collection including a magnetic metal core and metal organic framework (Fe₃O₄@Zr-BDC-NH₂—SO₄) disclosed herein and the barium adsorption affinity of the material.

### Example 1

Example 1 is an example of the iron oxide fabrication process. First, 6.1 g FeCl₃·6H₂O and 4.2 g FeSO₄·7H₂O were dissolved in 100 mL deionized water and heated to 90° C. (within half an hour in a small oil bath). Then, 10 mL of a 25 mol % ammonium hydroxide solution and 0.5 g of citric acid were dissolved in 50 mL deionized water and added to the mixture. The mixture was stirred at 90° C. for 30 min and then cooled to room temperature, where precipitation occurred. The iron oxide presented as brown precipitates which were collected after centrifugation of the colloidal solution at 8,000 rpm and washed with water three times. Upon washing the precipitates with water, iron oxide was obtained. More details of the synthesis process may be found in [insert reference to 18733-1689001/SA91689].

### Example 2

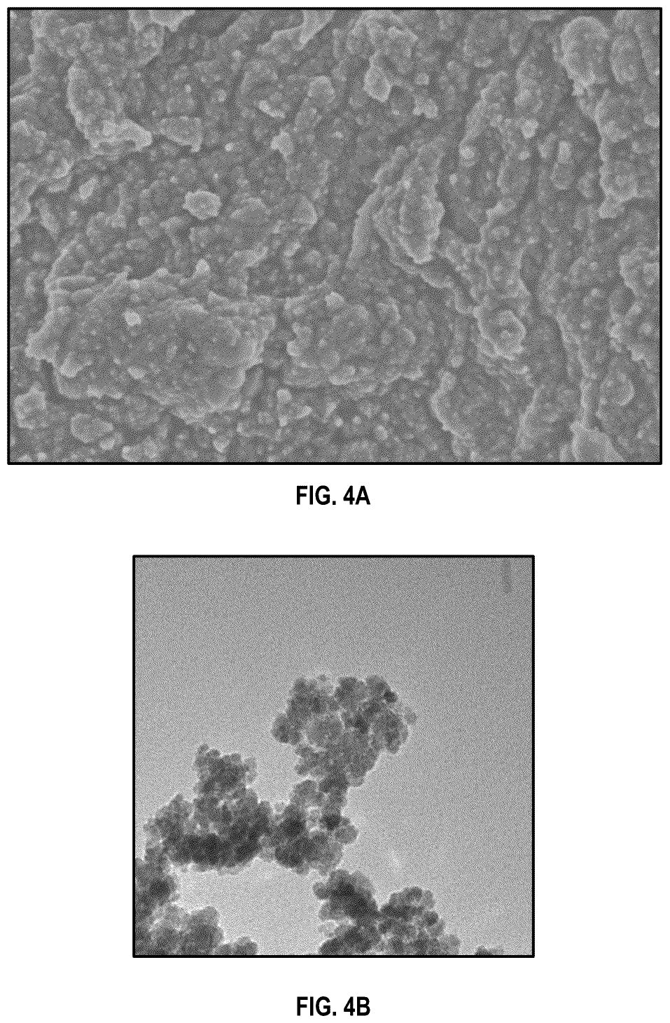

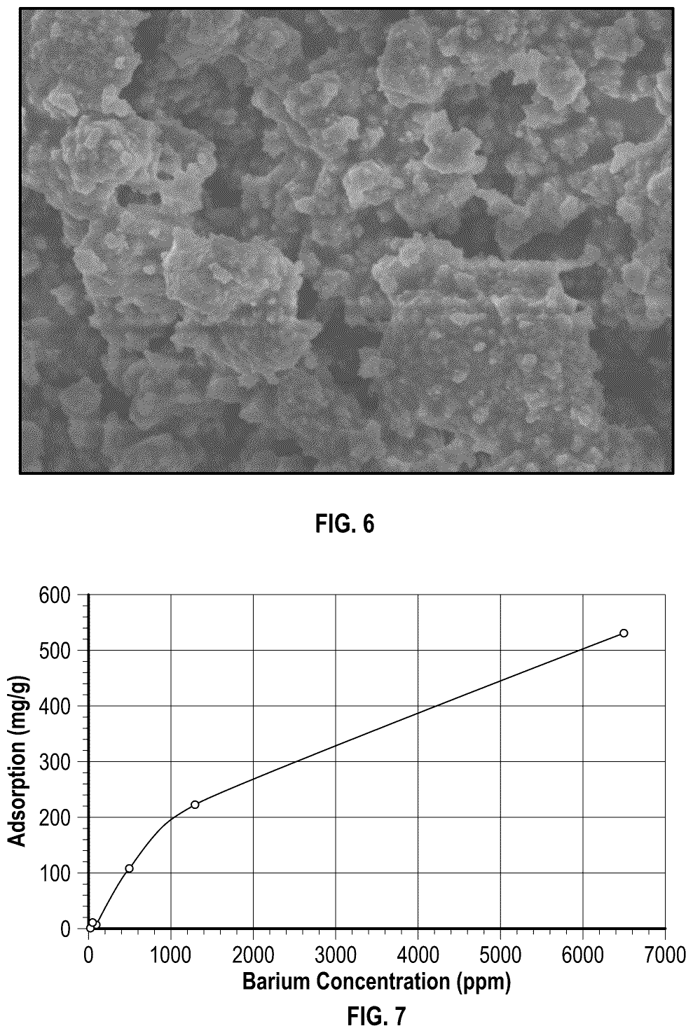

Example 2 shows characterization of Fe₃O₄@Zr-BDC-NH₂-SO₄ using Scanning Electron Microscopy (SEM) and Transmission Electron Microscopy (TEM). FIG. 4A is an SEM image of the magnetic core, carboxylic acid modified Fe₃O₄, which was observed to be nanoparticles in the size range of hundreds of nanometers. FIG. 4B is a TEM image of the carboxylic acid modified Fe₃O₄. FIG. 5A is an SEM image of the MOF, Zr-BDC-NH₂—SO₄, which presented as micrometer sized crystals. FIG. 5B is a TEM image of Zr-BDC-NH₂—SO₄. FIG. 6 shows an SEM image of the composition for barium collection, Fe₃O₄@Zr-BDC-NH₂—SO₄. As shown in the SEM image of FIG. 6, the composition for barium collection is a combination of the two materials, with MOF crystals coating on the surface of the magnetic cores.

### Example 3

Example 3 describes barium adsorption on Fe₃O₄@Zr-BDC-NH₂—SO₄ in deionized water. FIG. 7 illustrates the results of Example 3. This example describes the adsorption of barium on the synthesized Fe₃O₄@Zr-BDC-NH₂—SO₄ in deionized water with barium concentration are 25 ppm, 50 ppm, 100 ppm, 500 ppm, 1,300 ppm, and 6,500 ppm. A 10 mL solution was prepared by adding about 0.05 g of Fe₃O₄@Zr-BDC-NH₂—SO₄ to deionized water. The solution was left undisturbed for 2 hours of adsorption, after which, the Fe₃O₄@Zr-BDC-NH₂—SO₄ was removed by filtration through a 0.45 μm sieve. The solution was collected after filtration, and barium concentration was analyzed using inductively coupled plasma mass spectrometer. The resultant adsorption amount was 1.7 mg/g, 12 mg/g, 8.7 mg/g, 109 mg/g, 224 mg/g, and 534 mg/g for the solutions having an initial barium concentration of 25 ppm, 50 ppm, 100 ppm, 500 ppm, 1300 ppm, and 6500 ppm, respectively. The results are shown in a plot of adsorption capacity of barium (mg/g) versus initial concentration of barium (ppm) in FIG. 7. Overall, the composition for barium collection of one or more embodiments, Fe₃O₄@Zr-BDC-NH₂—SO₄, has a very high barium adsorption capacity in deionized water, as shown in FIG. 7.

### Example 4

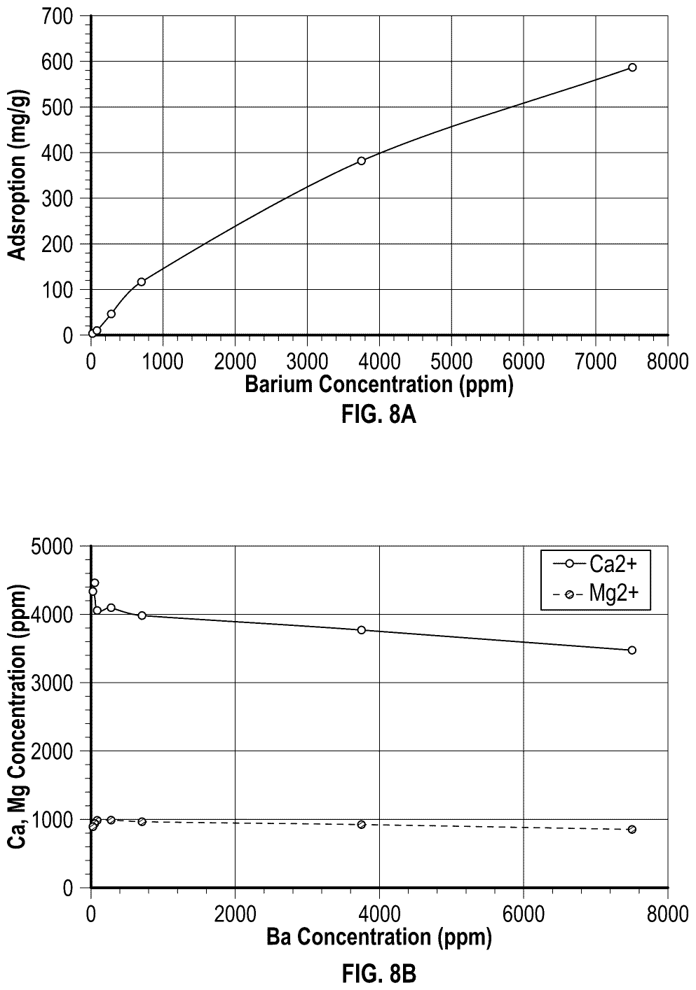

Example 4 shows barium adsorption on Fe₃O₄@Zr-BDC-NH₂—SO₄ in high salinity water. FIG. 8A illustrates the results of Example 4. This example describes the adsorption of barium on the synthesized Fe₃O₄@Zr-BDC-NH₂—SO₄ in high salinity water with barium concentration are 20 ppm, 40 ppm, 75 ppm, 250 ppm, 700 ppm, 3,750 ppm and 7,500 ppm. The high salinity water contains 18,626 ppm Na⁺, 4,360 Ca²⁺, 938 Mg²⁺, and 40,704 Cl³¹. A solution was prepared by adding about 0.05 g of Fe₃O₄@Zr-BDC-NH₂—SO₄ to 10 mL of the high salinity water. The solution was left undisturbed for 2 hours of adsorption, after which, the Fe₃O₄@Zr-BDC-NH₂—SO₄ was removed by filtration through a 0.45 μm sieve. The solution was collected after filtration, and barium concentration in the filtered solution was analyzed using inductively coupled plasma mass spectrometer. The resultant adsorption amount was 2.6 mg/g, 6.4 mg/g, 10.7 mg/g, 46.4 mg/g, 116 mg/g, 382 mg/g, and 586 mg/g, 20 ppm, 40 ppm, 75 ppm, 250 ppm, 700 ppm, 3,750 ppm, and 7,500 ppm, respectively. The results are shown in a plot of adsorption capacity of barium (mg/g) versus initial concentration of barium (ppm) in FIG. 8A. Overall, the composition for barium collection of one or more embodiments, Fe₃O₄@Zr-BDC-NH₂—SO₄, has a very high barium adsorption capacity in high salinity water as shown in FIG. 8A. The high concentration of ions has no effects on barium adsorption on this invention.

### Example 5

Example 5 describes other di-valent ions adsorption on Fe₃O₄@Zr-BDC-NH₂—SO₄ in high salinity water. FIG. 8B illustrates the results of Example 5. This example describes the co-adsorption of calcium and magnesium on the synthesized Fe₃O₄@Zr-BDC-NH₂—SO₄ in high salinity water with barium concentration are 20 ppm, 40 ppm, 75 ppm, 250 ppm, 700 ppm, 3,750 ppm and 7,500 ppm. The high salinity water contains 18,626 ppm Na⁺, 4,360 Ca²⁺, 938 Mg²⁺, and 40,704 Cl⁻. A solution was prepared by adding about 0.05 g of Fe₃O₄@Zr-BDC-NH₂—SO₄ to 10 mL of the high salinity water. The solution was left undisturbed for 2 hours of adsorption, after which, the Fe₃O₄@Zr-BDC-NH₂—SO₄ was removed by filtration through a 0.45 μm sieve. The solution was collected after filtration, and calcium and magnesium concentrations in the filtered solution were analyzed using inductively coupled plasma mass spectrometer. The results are shown in a plot of final concentration of calcium and magnesium (ppm) after 2 hour adsorption time versus initial concentration of barium (ppm) in FIG. 8B. In FIG. 8B, the calcium concentration decreased from a concentration of about 4,360 ppm to about 3,470 ppm over the full range of initial barium concentration values. This suggests that, regardless of the initial amount of barium in solution, the adsorption affinity toward calcium of the Fe₃O₄@Zr-BDC-NH₂—SO₄ material is quite low. In FIG. 8B, the magnesium concentration remained at a concentration of about 900 ppm over the full range of initial barium concentrations, indicating that the adsorption affinity toward magnesium of the Fe₃O₄@Zr-BDC-NH₂—SO₄ material is nearly zero. Example 5 confirms that Fe₃O₄@Zr-BDC-NH₂—SO₄ has a very high selectivity toward barium and low adsorption capacity towards other di-valent ions, such as calcium and magnesium.

Examples according to one or more embodiments provide evidence that the disclosed material has high barium loading capacity (>500 mg/g) and high selectivity in high salinity water. In the adsorption experiment in deionized water and high salinity water, the measured adsorption amount at most of this material is more than 500 mg/g. And the presence of calcium or magnesium has no interferences on the barium adsorption. The material shows high barium loading and high selectivity for efficient barium collection. Besides, with the magnetic core, the material can be separated with water using magnetic force, which is easier than centrifuge or filtration. The magnetic property of this invention facilitates the easy collection of barium.

What is claimed:

1. A composition for barium collection, comprising:
a core comprising a magnetic metal oxide; and
a metal organic framework material coated on a surface of the core, the metal organic framework material comprising:
a transition metal;
an organic ligand chemically bonded to the transition metal; and
an inorganic ion.

2. The composition of claim 1, wherein the composition for barium collection has a particle size in a range of 100 nm to 5000 nm.

3. The composition of claim 1, wherein the composition for barium collection has a pore size of from 5 Å to 10 Å.

4. The composition of claim 1, wherein the composition for barium collection has a surface area of greater than 100 m²/g.

5. The composition of claim 1, wherein the composition for barium collection has a saturation adsorption capacity toward barium of at least 500 mg/g.

6. The composition of claim 1, wherein the magnetic metal oxide has a particle size in a range of 10 nm to 30 nm.

7. The composition of claim 1 wherein the magnetic metal oxide is selected from the group consisting of Fe₂O₄, γ-Fe₂O₃, or Fe₂O₃ modified with oxides of Ba, Sr, Co, La, Mn, Zn, Ni, and combinations thereof.

8. The composition of claim 1, wherein the transition metal is selected from the group consisting of zirconium and chromium.

9. The composition of claim 1, wherein the organic ligand is selected from the group consisting of aminoterephthalic acid, terephthalic acid (BDC), 1,3,5-benzenetricarboxylic acid, 2-mercaptomalic acid, meso-dimercaptosuccinic acid and piperazine-1,4-dicarboxylic acid.

10. The composition of claim 1, wherein the inorganic ion is selected from the group consisting of sulfate.

11. The composition of claim 1, wherein a surface of the magnetic metal oxide comprises a carboxylic acid functional group.

12. A method for barium collection, comprising:
mixing a composition for barium collection with a water source containing barium, the composition comprising:
a core, comprising a magnetic metal oxide; and
a metal organic framework material coated on a surface of the core, the metal organic framework material comprising:
a transition metal;
an organic ligand, wherein the organic ligand is chemically bonded to the transition metal; and
an inorganic ion; and
adsorbing, using the composition for barium collection, an amount of barium from the water source to produce a barium-adsorbed composition and a resultant solution.

13. The method of claim 12, further comprising:
separating, using magnetic force, the barium-adsorbed composition from the resultant solution.

14. The method of claim 12, wherein the water source has a total dissolved solids concentration in a range of from 0 to 100.000 ppm.

15. The method of claim 12, wherein the water source has a concentration of calcium ions is in a range from 0 to 5,000 ppm.

16. The method of claim 12, wherein the water source has a concentration of magnesium ions is in a range from 0 to 1.000 ppm.

17. The method of claim 12, wherein the composition for barium collection has a saturation adsorption capacity toward barium of at least 500 mg/g.

18. The method of claim 12, wherein the water source is produced water.

19. A method for separating barium from produced water, comprising:
separating, using magnetic force, a barium-adsorbed composition from an admixture of produced water and a composition for barium collection, the composition for barium collection comprising
a core comprising a magnetic metal oxide, and
a metal organic framework material coated onto a surface of the core, the metal organic framework material comprising:
a transition metal;
an organic ligand chemically bonded to the transition metal; and
an inorganic ion.

20. The method of claim 19, wherein the composition for barium collection has a saturation adsorption capacity toward barium of at least 500 mg/g.
